(19) United States
(12) Patent Application Publication
(10) Pub. No.: US 2021/0385365 A1
(43) Pub. Date: Dec. 9, 2021

(54) DISPLAY NOTCH MITIGATION FOR CAMERAS AND PROJECTORS

(71) Applicant: QUALCOMM Incorporated, San Diego, CA (US)

(72) Inventors: Jian Ma, San Diego, CA (US); Sergiu Radu Goma, San Diego, CA (US)

(21) Appl. No.: 16/894,039

(22) Filed: Jun. 5, 2020

(51) Int. Cl. H04N 5/238; H04N 9/31

(52) U.S. Cl. CPC H04N 5/238; H04N 9/3194

(57) ABSTRACT

Methods, systems, and devices for display notch mitigation for cameras and projectors are described. A device may support receiving a plurality of light rays via an upper surface of a prism. The prism and a camera assembly of the device are positioned behind a display substrate of the device. The device may support reflecting the plurality of light rays across a reflection surface. The reflection surface may form an angle with the upper surface of the prism. The device may receiver the plurality of light rays via the camera assembly positioned behind the display substrate based on reflecting the plurality of light rays across the reflection surface. The device may additionally support emitting a plurality of light rays via a projector assembly, reflecting the plurality of light rays across the reflection surface, and emitting the plurality of light rays via the upper surface of the prism.

### BACKGROUND

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices. For example, some devices may have notches, hole punches, or cutouts in display screens. These notches may allow light to propagate, which may support functioning of hardware of some devices, such as cameras, projectors, sensors, or the like. In some cases, notches may reduce a usable area of a screen and degrade an aesthetic factor of the devices.

### SUMMARY

The described techniques relate to improved methods, systems, devices, and apparatuses that support display notch mitigation for cameras and projectors. Generally, the described techniques provide for reducing or eliminating display notches or cutouts. A prism (e.g., a right angle prism) may be used to reflect light to or from a component of a device (e.g., a camera, a projector, a sensor, etc.) that is located behind the display screen of a device. The device (e.g., a smartphone) may support receiving a plurality of light rays via an upper surface of a prism, wherein the prism and a camera assembly of the device are positioned behind a display substrate of the device. The device may support reflecting the plurality of light rays across a reflection surface (e.g., the hypotenuse of a right triangle), where the reflection surface may form an angle (e.g., a 45 degree angle) with the upper surface of the prism, and the device may support receiving the plurality of light rays via the camera assembly positioned behind the display substrate based at least in part on reflecting the plurality of light rays across the reflection surface. The device may additionally support emitting a plurality of light rays via a projector assembly, reflecting the plurality of light rays across a reflection surface, and emitting the plurality of light rays via the upper surface of the prism.

A method at a device is described. The method may include receiving a set of light rays via an upper surface of a prism, where the prism and a camera assembly of the device are positioned behind a display substrate of the device and the upper surface of the prism is positioned at an edge of the display substrate, reflecting the set of light rays across an optical reflection surface, the reflection surface forming an angle with the upper surface of the prism, and receiving the set of light rays via the camera assembly positioned behind the display substrate based on reflecting the set of light rays across the reflection surface.

An apparatus is described. The apparatus may include a processor, memory coupled with the processor, and instructions stored in the memory. The instructions may be executable by the processor to cause the apparatus to receive a set of light rays via an upper surface of a prism, where the prism and a camera assembly of the apparatus are positioned behind a display substrate of the apparatus and the upper surface of the prism is positioned at an edge of the display substrate, reflect the set of light rays across a reflection surface, the reflection surface forming an angle with the upper surface of the prism, and receive the set of light rays via the camera assembly positioned behind the display substrate based on reflecting the set of light rays across the reflection surface.

Another apparatus is described. The apparatus may include means for receiving a set of light rays via an upper surface of a prism, where the prism and a camera assembly of the apparatus are positioned behind a display substrate of the apparatus and the upper surface of the prism is positioned at an edge of the display substrate, reflecting the set of light rays across a reflection surface, the reflection surface forming an angle with the upper surface of the prism, and receiving the set of light rays via the camera assembly positioned behind the display substrate based on reflecting the set of light rays across the reflection surface.

A non-transitory computer-readable medium storing code at a device is described. The code may include instructions executable by a processor to receive a set of light rays via an upper surface of a prism, where the prism and a camera assembly of the device are positioned behind a display substrate of the device and the upper surface of the prism is positioned at an edge of the display substrate, reflect the set of light rays across a reflection surface, the reflection surface forming an angle with the upper surface of the prism, and receive the set of light rays via the camera assembly positioned behind the display substrate based on reflecting the set of light rays across the reflection surface.

Some examples of the method, apparatuses, and non-transitory computer-readable medium described herein may further include operations, features, means, or instructions for capturing an image via the device based on the received set of light rays via the camera assembly, and storing the captured image at a local memory or a remote memory associated with the device.

Some examples of the method, apparatuses, and non-transitory computer-readable medium described herein may further include operations, features, means, or instructions for performing a brightness correction operation based on the received set of light rays via the camera assembly, where capturing the image includes.

In some examples of the method, apparatuses, and non-transitory computer-readable medium described herein, performing the brightness correction operation may include operations, features, means, or instructions for performing the brightness correction operation based on an optical ray tracing operation on the received set of light rays.

Some examples of the method, apparatuses, and non-transitory computer-readable medium described herein may further include operations, features, means, or instructions for calibrating the camera assembly of the device based on the received set of light rays, where the set of light rays includes a uniform set of light rays, and performing the brightness correction operation includes performing the brightness correction operation based on calibrating the camera assembly.

Some examples of the method, apparatuses, and non-transitory computer-readable medium described herein may further include operations, features, means, or instructions for outputting a representation of a brightness corrected image based on performing the brightness correction.

Some examples of the method, apparatuses, and non-transitory computer-readable medium described herein may further include operations, features, means, or instructions for receiving the set of light rays via a lower surface of the prism based on the lower surface of the prism being flush with the camera assembly.

Some examples of the method, apparatuses, and non-transitory computer-readable medium described herein may further include operations, features, means, or instructions for receiving the set of light rays via a lower surface of the prism based on a gap between the lower surface of the prism and the camera assembly.

Some examples of the method, apparatuses, and non-transitory computer-readable medium described herein may further include operations, features, means, or instructions for configuring the dimensions of the upper surface of the prism to be equal to the dimensions of the reflection surface.

Some examples of the method, apparatuses, and non-transitory computer-readable medium described herein may further include operations, features, means, or instructions for configuring the dimensions of the upper surface of the prism to be less than dimensions of the reflection surface.

In some examples of the method, apparatuses, and non-transitory computer-readable medium described herein, the camera assembly includes an infrared camera, a time-of-flight camera, a thermographic camera, or a visible camera.

A method at a device is described. The method may include emitting a set of light rays via a projector assembly positioned behind a display substrate of the device, reflecting the set of light rays across a reflection surface, the reflection surface forming an angle with an upper surface of a prism, where the upper surface of the prism is positioned at an edge of the display substrate, and emitting the set of light rays via the upper surface of the prism based on reflecting the set of light rays across the reflection surface.

An apparatus is described. The apparatus may include a processor, memory coupled with the processor, and instructions stored in the memory. The instructions may be executable by the processor to cause the apparatus to emit a set of light rays via a projector assembly positioned behind a display substrate of the apparatus, reflect the set of light rays across a reflection surface, the reflection surface forming an angle with an upper surface of a prism, where the upper surface of the prism is positioned at an edge of the display substrate, and emit the set of light rays via the upper surface of the prism based on reflecting the set of light rays across the reflection surface.

Another apparatus is described. The apparatus may include means for emitting a set of light rays via a projector assembly positioned behind a display substrate of the apparatus, reflecting the set of light rays across a reflection surface, the reflection surface forming an angle with an upper surface of a prism, where the upper surface of the prism is positioned at an edge of the display substrate, and emitting the set of light rays via the upper surface of the prism based on reflecting the set of light rays across the reflection surface.

A non-transitory computer-readable medium storing code at a device is described. The code may include instructions executable by a processor to emit a set of light rays via a projector assembly positioned behind a display substrate of the device, reflect the set of light rays across a reflection surface, the reflection surface forming an angle with an upper surface of a prism, where the upper surface of the prism is positioned at an edge of the display substrate, and emit the set of light rays via the upper surface of the prism based on reflecting the set of light rays across the reflection surface.

Some examples of the method, apparatuses, and non-transitory computer-readable medium described herein may further include operations, features, means, or instructions for performing a brightness correction operation based on the emitted set of light rays via the projector assembly, and outputting a representation of an image via the projector assembly.

In some examples of the method, apparatuses, and non-transitory computer-readable medium described herein, performing the brightness correction operation may include operations, features, means, or instructions for performing the brightness correction operation based on an optical ray tracing operation on the emitted set of light rays.

Some examples of the method, apparatuses, and non-transitory computer-readable medium described herein may further include operations, features, means, or instructions for calibrating the projector assembly of the device based on the emitted set of light rays, where the set of light rays includes a uniform set of light rays, and performing the brightness correction operation includes, and performing the brightness correction operation based on calibrating the projector assembly.

Some examples of the method, apparatuses, and non-transitory computer-readable medium described herein may further include operations, features, means, or instructions for emitting the set of light rays via a lower surface of the prism based on that the lower surface of the prism may be flush with the projector assembly.

Some examples of the method, apparatuses, and non-transitory computer-readable medium described herein may further include operations, features, means, or instructions for emitting the set of light rays via a lower surface of the prism based on a gap between the lower surface of the prism and the projector assembly.

In some examples of the method, apparatuses, and non-transitory computer-readable medium described herein, the projector assembly includes a structured light projector, a flood illumination projector, or a time-of-flight projector.

A method of apparatus including is described. The method may include a prism configured to receive a set of light rays via an upper surface of the prism, where the prism and a camera assembly of the apparatus are positioned behind a display substrate of the apparatus and the upper surface of the prism is positioned at an edge of the display substrate, a reflection surface configured to reflect the set of light rays across the reflection surface, the reflection surface forming an angle with the upper surface of the prism, and a camera assembly configured to receive the set of light rays based on reflecting the set of light rays across the reflection surface, where the camera assembly is positioned behind the display substrate.

An apparatus is described. The apparatus may include a processor, memory coupled with the processor, and instructions stored in the memory. The instructions may be executable by the processor to cause the apparatus to a prism configured to receive a set of light rays via an upper surface of the prism, where the prism and a camera assembly of the apparatus are positioned behind a display substrate of the apparatus and the upper surface of the prism is positioned at an edge of the display substrate, a reflection surface configured to reflect the set of light rays across the reflection surface, the reflection surface forming an angle with the upper surface of the prism, and a camera assembly configured to receive the set of light rays based on reflecting the set of light rays across the reflection surface, where the camera assembly is positioned behind the display substrate.

Another apparatus is described. The apparatus may include means for a prism configured to receive a set of light rays via an upper surface of the prism, where the prism and a camera assembly of the apparatus are positioned behind a display substrate of the apparatus and the upper surface of the prism is positioned at an edge of the display substrate, a reflection surface configured to reflect the set of light rays across the reflection surface, the reflection surface forming an angle with the upper surface of the prism, and a camera assembly configured to receive the set of light rays based on reflecting the set of light rays across the reflection surface, where the camera assembly is positioned behind the display substrate.

A non-transitory computer-readable medium storing code for an apparatus is described. The code may include instructions executable by a processor to a prism configured to receive a set of light rays via an upper surface of the prism, where the prism and a camera assembly of the apparatus are positioned behind a display substrate of the apparatus and the upper surface of the prism is positioned at an edge of the display substrate, a reflection surface configured to reflect the set of light rays across the reflection surface, the reflection surface forming an angle with the upper surface of the prism, and a camera assembly configured to receive the set of light rays based on reflecting the set of light rays across the reflection surface, where the camera assembly is positioned behind the display substrate.

### BRIEF DESCRIPTION OF THE DRAWINGS

FIG. 1 illustrates an example of a system for device displays that supports display notch mitigation for cameras and projectors in accordance with aspects of the present disclosure.

FIG. 2 illustrates an example of a device that supports display notch mitigation for cameras and projectors in accordance with aspects of the present disclosure.

FIG. 3 illustrates an example of a device configuration technique that supports display notch mitigation for cameras and projectors in accordance with aspects of the present disclosure.

FIGS. 4 and 5 show block diagrams of devices that support display notch mitigation for cameras and projectors in accordance with aspects of the present disclosure.

FIG. 6 shows a block diagram of a multimedia manager that supports display notch mitigation for cameras and projectors in accordance with aspects of the present disclosure.

FIG. 7 shows a diagram of a system including a device that supports display notch mitigation for cameras and projectors in accordance with aspects of the present disclosure.

FIGS. 8 and 9 show flowcharts illustrating methods that support display notch mitigation for cameras and projectors in accordance with aspects of the present disclosure.

### DETAILED DESCRIPTION

Device displays often have cut outs (e.g., a notch, a hole-punch, etc.) and the cut outs often decrease a usable size of the displays and reduce display aesthetic. A device may include notches to accommodate front facing components such as cameras, projectors, sensors, or the like. Notches may additionally increase a difficulty of mobile application design, as some devices may include notches of varying size and shape. In some cases, a display notch may prevent an application from displaying information to a user, while in some additional or alternative cases, application developers may spend additional time developing different application versions for different display notch configurations. As such, display notches may prevent proper functioning of a mobile application, reduce the usable screen size of a device, and decrease device aesthetic.

According to techniques described herein, a device may eliminate or reduce display cutouts, thereby improving ease of mobile application development, increasing available screen size, and improving device aesthetic. A device may be configured with a prism (e.g., a right-angle prism) proximate to a component assembly (e.g., a camera assembly, a projector assembly, etc.), which may support numerous component assembly mounting positions (e.g., behind a display screen). The prism may reflect light into or out of the component assembly. For example, light rays may be received via an upper surface of the prism, reflected across a reflection surface of the prism, and received by the camera assembly. In some additional or alternative cases, light rays may be emitted from a projector assembly, reflected across the reflection surface of the prism, and emitted via the upper surface of the prism.

In some cases, a digital brightness correction procedure may be performed. The digital brightness correction may be performed based on the dimensions of the prism. For example, the dimensions of the upper surface of the prism may be trimmed or reduced to fit a small open edge of the display, which may introduce vignetting on large angle rays and decrease the quality of images captured via the prism. The digital brightness correction procedure may improve image quality, and the procedure may include ray tracing and/or calibrating the camera assembly with a uniform light source. In some cases, the device may be configured to eliminate or reduce the distance between the prism and the component assembly to improve the relative illumination performance of the device.

Aspects of the disclosure are initially described in the context of a multimedia system. Aspects of the disclosure are then described with respect to a device and a device configuration technique. Aspects of the disclosure are further illustrated by and described with reference to apparatus diagrams, system diagrams, and flowcharts that relate to display notch mitigation for cameras and projectors.

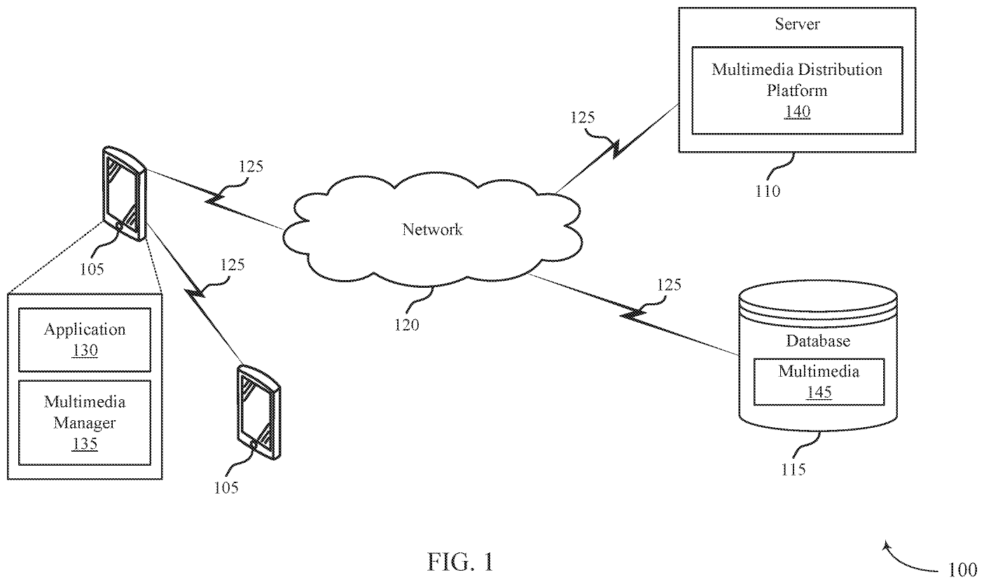

FIG. 1 illustrates a multimedia system 100 for a device that supports display notch mitigation for cameras and projectors in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports display notch mitigation for cameras and projectors, such as multimedia packets, multimedia data, or multimedia control information, via network 120 using communications links 125. In some cases, a portion or all of the techniques described herein supporting display notch mitigation for cameras and projectors may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125. The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support display notch mitigation for cameras and projectors, according to the techniques described herein.

The server 110 may be a data server, a cloud server, a server associated with a multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support display notch mitigation for cameras and projectors associated with the multimedia 145. The device 105 may retrieve the stored data from the database 115 via the network 120 using communications links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The communications links 125 may transmit bidirectional communications and/or unidirectional communications. In some examples, the communications links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

A server 110 may perform a digital brightness procedure on images captured by a device 105. In some cases, an image captured by a device 105 may include vignetting (e.g., the brightness or saturation of the image may be reduced toward the periphery of the image). The digital brightness procedure may be based on ray tracing and/or a known relative illumination curve (e.g., as expressed by cos\hat{ }4 (θ)). In some cases, the device 105 may indicate prism information (e.g., the type of prism that was used to capture the image, the dimensions of the prism that was used to capture the image, etc.), and the server 110 may perform the digital brightness procedure based on the prism information.

A device 105 may eliminate or reduce display cutouts (e.g., notches, hole punches, etc.). For example, the device 105 may use a prism to reflect light into or away from a component assembly (e.g., a camera, a projector, a sensor, etc.) that is located behind a display panel. In some cases, an upper surface of the prism may be mounted proximate to the display panel. In some cases, the component assembly may be mounted proximate to a lower surface of the prism, while in some additional or alternative cases, a small gap (e.g., 0.5 millimeters, 1.0 millimeter, 2.0 millimeters) may exist between the lower surface of the prism and the component assembly. The techniques described herein may provide improvements in mobile application design, image brightness, and device aesthetic. The techniques described herein may also provide benefits and enhancements to the operation of the devices 105. For example, by improving mobile application design, the operational characteristics, such as power consumption, processor utilization (e.g., DSP, CPU, GPU, ISP processing utilization), and memory usage of the devices 105 may be reduced.

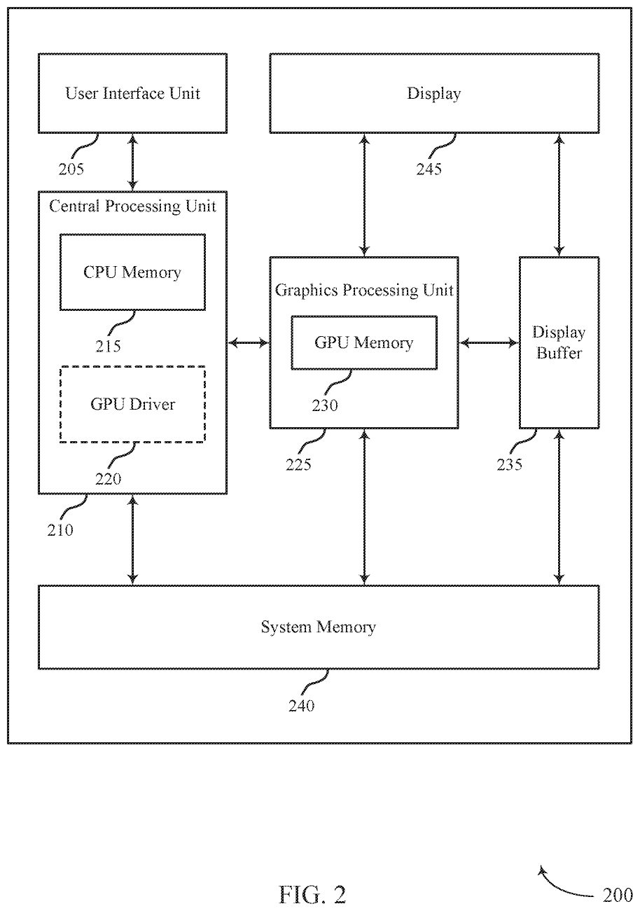

FIG. 2 illustrates an example of a device 200 that supports display notch mitigation for cameras and projectors in accordance with aspects of the present disclosure. In the example of FIG. 2, the device 200 includes a central processing unit (CPU) 210 having a CPU memory 215, a GPU 225 having a GPU memory 230, a display 245, a display buffer 235 storing data associated with rendering, a user interface unit 205, and a system memory 240. For example, the system memory 240 may store a GPU driver 220 (illustrated as being contained within the CPU 210 as described below) having a compiler, a GPU program, a locally-compiled GPU program, and the like. The user interface unit 205, the CPU 210, the GPU 225, the system memory 240, and the display 245 may communicate with each other (e.g., using a system bus).

Examples of the CPU 210 include, but are not limited to, a digital signal processor (DSP), general purpose microprocessor, application specific integrated circuit (ASIC), field programmable logic array (FPGA), or other equivalent integrated or discrete logic circuitry. Although the CPU 210 and the GPU 225 are illustrated as separate units in the example of FIG. 2, in some examples, the CPU 210 and the GPU 225 may be integrated into a single unit. The CPU 210 may execute one or more software applications. Examples of the applications may include operating systems, word processors, web browsers, e-mail applications, spreadsheets, video games, audio and/or video capture, playback or editing applications, or other such applications that initiate the generation of image data to be presented via the display 245. As illustrated, the CPU 210 may include the CPU memory 215. For example, the CPU memory 215 may represent on-chip storage or memory used in executing machine or object code. The CPU memory 215 may include one or more volatile or non-volatile memories or storage devices, such as flash memory, a magnetic data media, an optical storage media, etc. The CPU 210 may be able to read values from or write values to the CPU memory 215 more quickly than reading values from or writing values to the system memory 240, which may be accessed, e.g., over a system bus.

The GPU 225 may represent one or more dedicated processors for performing graphical operations. That is, for example, the GPU 225 may be a dedicated hardware unit having fixed function and programmable components for rendering graphics and executing GPU applications. The GPU 225 may also include a DSP, a general purpose microprocessor, an ASIC, an FPGA, or other equivalent integrated or discrete logic circuitry. The GPU 225 may be built with a highly-parallel structure that provides more efficient processing of complex graphic-related operations than the CPU 210. For example, the GPU 225 may include a plurality of processing elements that are configured to operate on multiple vertices or pixels in a parallel manner. The highly parallel nature of the GPU 225 may allow the GPU 225 to generate graphic images (e.g., graphical user interfaces and two-dimensional or three-dimensional graphics scenes) for the display 245 more quickly than the CPU 210.

The GPU 225 may, in some instances, be integrated into a motherboard of the device 200. In other instances, the GPU 225 may be present on a graphics card that is installed in a port in the motherboard of the device 200 or may be otherwise incorporated within a peripheral device configured to interoperate with the device 200. As illustrated, the GPU 225 may include the GPU memory 230. For example, the GPU memory 230 may represent on-chip storage or memory used in executing machine or object code. The GPU memory 230 may include one or more volatile or non-volatile memories or storage devices, such as flash memory, a magnetic data media, an optical storage media, etc. The GPU 225 may be able to read values from or write values to the GPU memory 230 more quickly than reading values from or writing values to the system memory 240, which may be accessed, e.g., over a system bus. That is, the GPU 225 may read data from and write data to the GPU memory 230 without using the system bus to access off-chip memory. This operation may allow the GPU 225 to operate in a more efficient manner by reducing the need for the GPU 225 to read and write data via the system bus, which may experience heavy bus traffic.

The display 245 represents a unit capable of displaying video, images, text or any other type of data for consumption by a viewer. The display 245 may include a liquid-crystal display (LCD), a light emitting diode (LED) display, an organic LED (OLED), an active-matrix OLED (AMOLED), or the like. The display buffer 235 represents a memory or storage device dedicated to storing data for presentation of imagery, such as computer-generated graphics, still images, video frames, or the like for the display 245. The display buffer 235 may represent a two-dimensional buffer that includes a plurality of storage locations. The number of storage locations within the display buffer 235 may, in some cases, generally correspond to the number of pixels to be displayed on the display 245. For example, if the display 245 is configured with 640×480 pixels, the display buffer 235 may have 640×480 storage locations storing pixel color and intensity information, such as red, green, and blue pixel values, or other color values. The display buffer 235 may store the final pixel values for each of the pixels processed by the GPU 225. The display 245 may retrieve the final pixel values from the display buffer 235 and display the final image based on the pixel values stored in the display buffer 235.

The user interface unit 205 represents a unit with which a user may interact with or otherwise interface to communicate with other units of the device 200, such as the CPU 210. Examples of the user interface unit 205 include, but are not limited to, a trackball, a mouse, a keyboard, and other types of input devices. The user interface unit 205 may also be, or include, a touch screen and the touch semen may be incorporated as part of the display 245. The system memory 240 may include one or more computer-readable storage media. Examples of the system memory 240 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. The system memory 240 may store program modules and/or instructions that are accessible for execution by the CPU 210. Additionally, the system memory 240 may store user applications and application surface data associated with the applications. The system memory 240 may in some cases store information for use by and/or information generated by other components of the device 200. For example, the system memory 240 may act as a device memory for the GPU 225 and may store data to be operated on by the GPU 225 as well as data resulting from operations performed by the GPU 225.

In some examples, the system memory 240 may include instructions that cause the CPU 210 or the GPU 225 to perform the functions ascribed to the CPU 210 or the GPU 225 in aspects of the present disclosure. The system memory 240 may, in some examples, be considered as a non-transitory storage medium. The term “non-transitory” should not be interpreted to mean that the system memory 240 is non-movable. As one example, the system memory 240 may be removed from the device 200 and moved to another device. As another example, a system memory substantially similar to the system memory 240 may be inserted into the device 200. In certain examples, a non-transitory storage medium may store data that can, over time, change (e.g., in RAM).

The system memory 240 may store a GPU driver 220 and compiler, a GPU program, and a locally-compiled GPU program. The GPU driver 220 may represent a computer program or executable code that provides an interface to access the GPU 225. The CPU 210 may execute the GPU driver 220 or portions thereof to interface with the GPU 225 and, for this reason, the GPU driver 220 is shown in the example of FIG. 2 within the CPU 210. The GPU driver 220 may be accessible to programs or other executables executed by the CPU 210, including the GPU program stored in the system memory 240. Thus, when one of the software applications executing on the CPU 210 includes graphics processing, the CPU 210 may provide graphics commands and graphics data to the GPU 225 for rendering to the display 245 (e.g., via the GPU driver 220).

In some cases, the GPU program may include code written in a high level (HL) programming language, e.g., using an application programming interface (API). Examples of APIs include Open Graphics Library (“OpenGL”), DirectX, Render-Man. WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of the GPU 225 to execute commands without user knowledge as to the specifics of the hardware components. In order to process the graphics rendering instructions, the CPU 210 may issue one or more rendering commands to the GPU 225 (e.g., through the GPU driver 220) to cause the GPU 225 to perform some or all of the rendering of the graphics data. In some examples, the graphics data to be rendered may include a list of graphics primitives (e.g., points, lines, triangles, quadrilaterals, etc.).

The GPU program stored in the system memory 240 may invoke or otherwise include one or more functions provided by the GPU driver 220. The CPU 210 generally executes the program in which the GPU program is embedded and, upon encountering the GPU program, passes the GPU program to the GPU driver 220. The CPU 210 executes the GPU driver 220 in this context to process the GPU program. That is, for example, the GPU driver 220 may process the GPU program by compiling the GPU program into object or machine code executable by the GPU 225. This object code may be referred to as a locally-compiled GPU program. In some examples, a compiler associated with the GPU driver 220 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, the CPU 210 and the GPU 225).

In the example of FIG. 2, the compiler may receive the GPU program from the CPU 210 when executing HL code that includes the GPU program. That is, a software application being executed by the CPU 210 may invoke the GPU driver 220 (e.g., via a graphics API) to issue one or more commands to the GPU 225 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to the GPU 225 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), the GPU driver 220 may formulate one or more commands that specify one or more operations for the GPU 225 to perform in order to render the primitive. When the GPU 225 receives a command from the CPU 210, it may decode the command and configure one or more processing elements to perform the specified operation and may output the rendered data to the display buffer 235.

The GPU 225 generally receives the locally-compiled GPU program, and then, in some instances, the GPU 225 renders one or more images and outputs the rendered images to the display buffer 235. For example, the GPU 225 may generate a number of primitives to be displayed at the display 245. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by the GPU 225 for display as an image (or frame in the context of video data) via the display 245. The GPU 225 may transform primitives and other attributes (e.g., that define a color, texture, lighting, camera configuration, or other aspect) of the primitives into a so-called “world space” by applying one or more model transforms (which may also be specified in the state data). Once transformed, the GPU 225 may apply a view transform for the active camera (which again may also be specified in the state data defining the camera) to transform the coordinates of the primitives and lights into the camera or eye space. The GPU 225 may also perform vertex shading to render the appearance of the primitives in view of any active lights. The GPU 225 may perform vertex shading in one or more of the above model, world, or view space.

Once the primitives are shaded, the GPU 225 may perform projections to project the image into a canonical view volume. After transforming the model from the eye space to the canonical view volume, the GPU 225 may perform clipping to remove any primitives that do not at least partially reside within the canonical view volume. That is, the GPU 225 may remove any primitives that are not within the frame of the camera. The GPU 225 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, the GPU 225 may then rasterize the primitives. Generally, rasterization may refer to the task of taking an image described in a vector graphics format and converting it to a raster image (e.g., a pixelated image) for output on a video display or for storage in a bitmap file format.

A GPU 225 may include a dedicated fast bin buffer (e.g., a fast memory buffer, such as GMEM, which may be referred to by the GPU memory 230). As discussed herein, a rendering surface may be divided into bins. In some cases, the bin size is determined by format (e.g., pixel color and depth information) and render target resolution divided by the total amount of GMEM. The number of bins may vary based on the device 200 hardware, target resolution size, and target display format. A rendering pass may draw (e.g., render, write, etc.) pixels into GMEM (e.g., with a high bandwidth that matches the capabilities of the GPU). The GPU 225 may then resolve the GMEM (e.g., burst write blended pixel values from the GMEM, as a single layer, to the display buffer 235 or a frame buffer in the system memory 240). Such may be referred to as bin-based or tile-based rendering. When all bins are complete, the driver may swap buffers and start the binning process again for a next frame.

The device 200 may represent a smartphone, a tablet, or the like, and may utilize a prism to reflect light to or from a component (e.g., a camera, a projector, a sensor) associated with the device 200. The prism (e.g., a right-angle prism) may be an example of an optical prism, and in some cases, the prism may be mounted proximate to the display 245. The device 200 may perform a digital brightness correction procedure on images captured or projected by the device 200. In some cases, an image associated with the device 200 may include vignetting (e.g., the brightness or saturation of the image may be reduced toward the periphery of the image). The digital brightness correction procedure may be based on ray tracing and/or a known relative illumination curve (e.g., as expressed by cos⁴ (θ)). In some cases, the device 200 may utilize the GPU 225 to perform the digital brightness correction. In some cases, the display 245 may present an image, and the GPU 225 may perform real-time ray tracing, which may reduce image vignetting and improve the quality of the image. In some additional or alternative examples, a projector associated with the device 200 may project images, and the quality of the images may be improved based on real time ray tracing performed by the GPU 225.

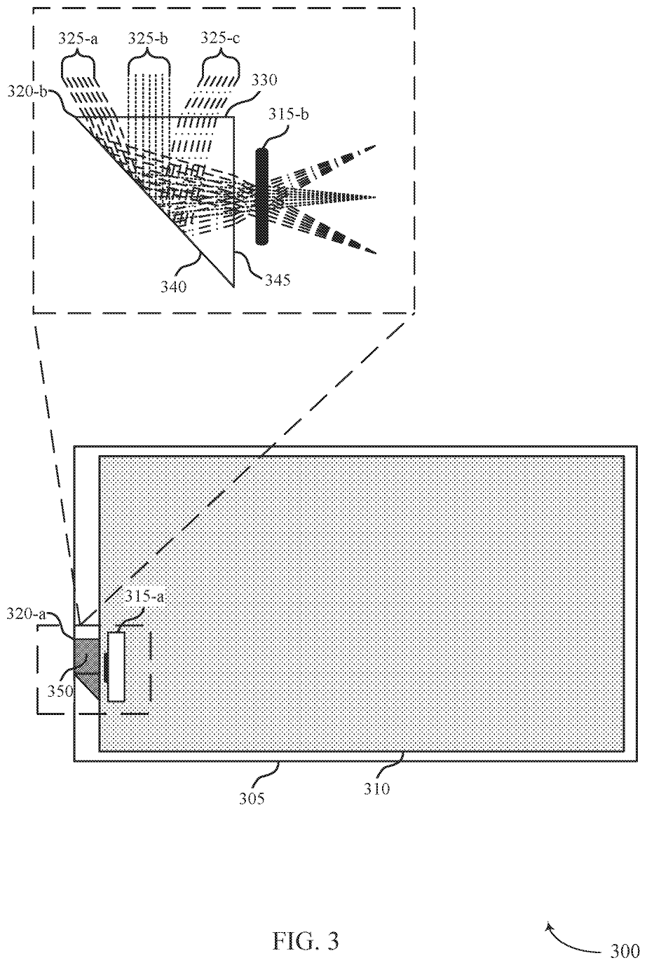

FIG. 3 illustrates an example of a device configuration technique 300 that supports display notch mitigation for cameras and projectors in accordance with aspects of the present disclosure. In some examples, the device configuration technique 300 may implement aspects of the multimedia system 100. The device configuration technique 300 may include a device 305 with a display 310. The device 305 may also include a prism 320 and a component 315, which may be a camera (e.g., an infrared camera, a near infrared camera, shortwave infrared, a time-of-flight camera, a visible camera, etc.), a projector (e.g., a structured light projector, a flood light illumination projector, a time-of-flight projector, etc.), or the like. In some cases, the prism 320 may be constructed from or include components of glass, plastic, fluoride, or any combination thereof.

The device configuration technique 300 may eliminate or reduce display cut outs by using a prism 320 (e.g., a right angle prism) to reflect light rays 325 to or from a component 315. The component 315 may be located at any edge of the display 310, and the device 305 may include multiple components 315 and/or multiple prisms 320. In some examples, configuring the device 305 with a prism 320 at the edge of the display 310 (e.g., a display substrate, a display panel, etc.) may support placement of the component 315 behind the display 310, which may reduce or eliminate display cutouts (e.g., notches) in the display 310.

The component 315 may be a camera, and the camera may receive light rays 325 through the prism 320. For example, the light rays 325 may enter the prism 320 through an upper surface 330, be reflected over the edge 340 (e.g., a reflection surface, the hypotenuse of a right angle prism, etc.), pass through the lower surface 345, and be received by the component 315, for example, a camera. Alternatively, the component 315 may be a projector, and the projector may emit light rays 325 through the prism 320. For example, the light rays 325 may enter the prism 320 through the lower surface 345, be reflected over the edge 340, and pass through the upper surface 330.

The prism 320 may be in contact with the component 315. For example, the lower surface 345 may be in contact with the component 315. In some examples, a gap (e.g., 0.25 millimeters, 0.5 millimeters, 1.0 millimeter, 2.0 millimeters, etc.) may exist between the lower surface 345 and the component 315. Some or all of the surface above the prism 320 (e.g., the device 305 surface proximate to the upper surface 330) may be transparent to allow the light rays 325 to enter and/or exit the prism 320. The upper surface 330 may be in contact with the device 305, or a small gap (e.g., 0.25 millimeters, 0.5 millimeters, 1.0 millimeter, 2.0 millimeters, etc.) may exist between the upper surface 330 and the device 305. In some cases, the dimensions of the upper surface 330 may match the dimensions of the lower surface 345, and in some additional or alternative cases, the dimensions of the upper surface 330 may be smaller than the dimensions of the lower surface 345. In some cases, the dimensions of the upper surface 330 may match the dimensions of the display opening 350, and in some additional or alternative cases, the dimensions of the upper surface 330 may be smaller than the dimensions of the display opening 350. The display opening 350 may correspond to an area of the device 305 (e.g., a translucent area) that allows light to pass through (e.g., while the light is traveling to or from the prism). For example, the upper surface 330 may be trimmed or decreased (e.g., trimmed with respect to the lower surface 345). Decreasing the dimensions of the upper surface 330 may decrease the footprint of the prism 320, thereby increasing design flexibility and decreasing or eliminating bezels of the device 305.

In some cases, vignetting may occur based on the prism 320. For example, vignetting may occur based on a reduction in dimensions of the upper surface 330 and/or the edge 340. For example, the dimensions of the upper surface 330 may be reduced with respect to the dimension of the lower surface 345, and the dimensions of the edge 340 may be reduced based on the size of the upper surface 330. In some cases, a section of the upper surface 330 that is proximate the edge 340 may be trimmed, and in some additional or alternative cases, a section of the edge 340 that is proximate the upper surface 330 may be trimmed. Vignetting may be present in captured images or projected images, and vignetting may be reduced through a digital brightness correction procedure. The digital brightness correction procedure may include calibrating the component 315 with a uniform light source, performing optical ray tracing, performing an illumination correction, or a combination thereof. In some cases, the device 305 may be calibrated with a uniform light source based on the dimensions of the prism 320, which may improve the performance of the device 305.

The device 305 may store an image captured by the component 315 and perform ray tracing on the image to improve the image brightness and quality. The device 305 may perform image illumination correction based on a relative illumination curve (e.g., as expressed by cos⁴ (θ)). Theta may represent an angle between the light rays 325-a and the light rays 325-b, and the device 305 may correct an image based on comparing an observed relative illumination curve and a known relative illumination curve (e.g., as expressed by as expressed by cos⁴ (θ)). In some cases, vignetting may occur on large angle arrays, and a brightness correction procedure may improve a quality of images and/or videos captured, projected, or generated by the device 305.

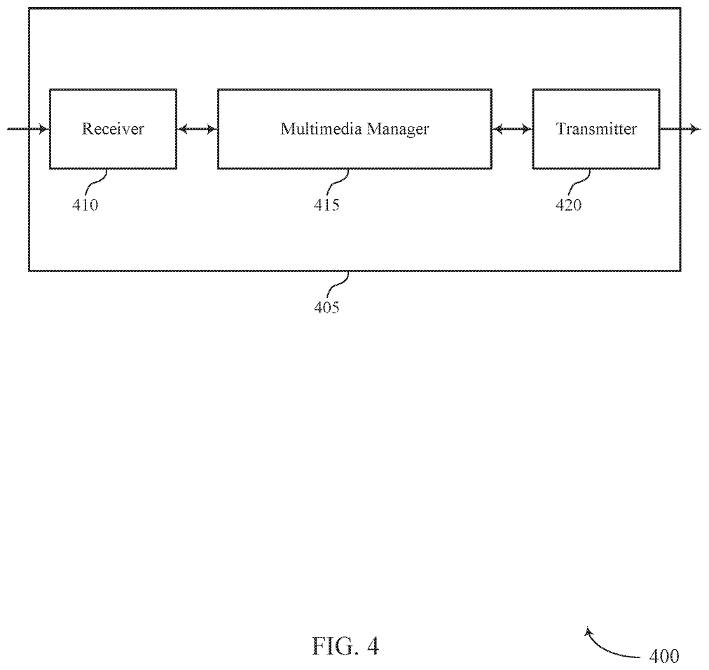

FIG. 4 shows a block diagram 400 of a device 405 that supports display notch mitigation for cameras and projectors in accordance with aspects of the present disclosure. The device 405 may be an example of aspects of a device as described herein. The device 405 may include a receiver 410, a multimedia manager 415, and a transmitter 420. The device 405 may also include a processor. Each of these components may be in communication with one another (e.g., via one or more buses).

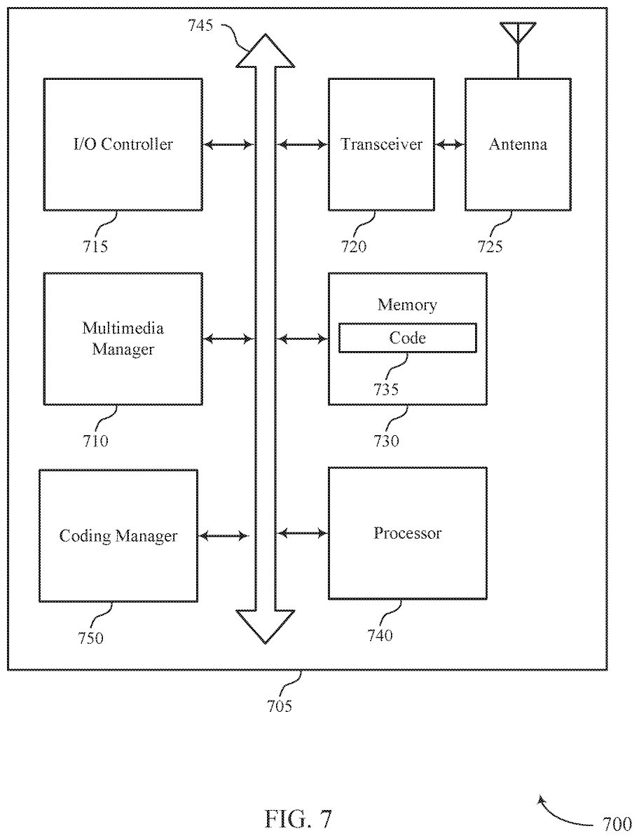

The receiver 410 may receive information such as packets, user data, or control information associated with various information channels (e.g., control channels, data channels, and information related to display notch mitigation for cameras and projectors, etc.). Information may be passed on to other components of the device 405. The receiver 410 may be an example of aspects of the transceiver 720 described with reference to FIG. 7. The receiver 410 may utilize a single antenna or a set of antennas.

The multimedia manager 415 may receive a set of light rays via an upper surface of a prism, where the prism and a camera assembly of the device are positioned behind a display substrate of the device and the upper surface of the prism is positioned at an edge of the display substrate, reflect the set of light rays across a reflection surface, the reflection surface forming an angle with the upper surface of the prism, and receive the set of light rays via the camera assembly positioned behind the display substrate based on reflecting the set of light rays across the reflection surface. The multimedia manager 415 may also emit a set of light rays via a projector assembly positioned behind a display substrate of the device, reflect the set of light rays across a reflection surface, the reflection surface forming an angle with an upper surface of a prism, where the upper surface of the prism is positioned at an edge of the display substrate, and emit the set of light rays via the upper surface of the prism based on reflecting the set of light rays across the reflection surface. The multimedia manager 415 may be an example of aspects of the multimedia manager 710 described herein.

The multimedia manager 415, or its sub-components, may be implemented in hardware, code (e.g., software or firmware) executed by a processor, or any combination thereof. If implemented in code executed by a processor, the functions of the multimedia manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The multimedia manager 415, or its sub-components, may be physically located at various positions, including being distributed such that portions of functions are implemented at different physical locations by one or more physical components. In some examples, the multimedia manager 415, or its sub-components, may be a separate and distinct component in accordance with various aspects of the present disclosure. In some examples, the multimedia manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

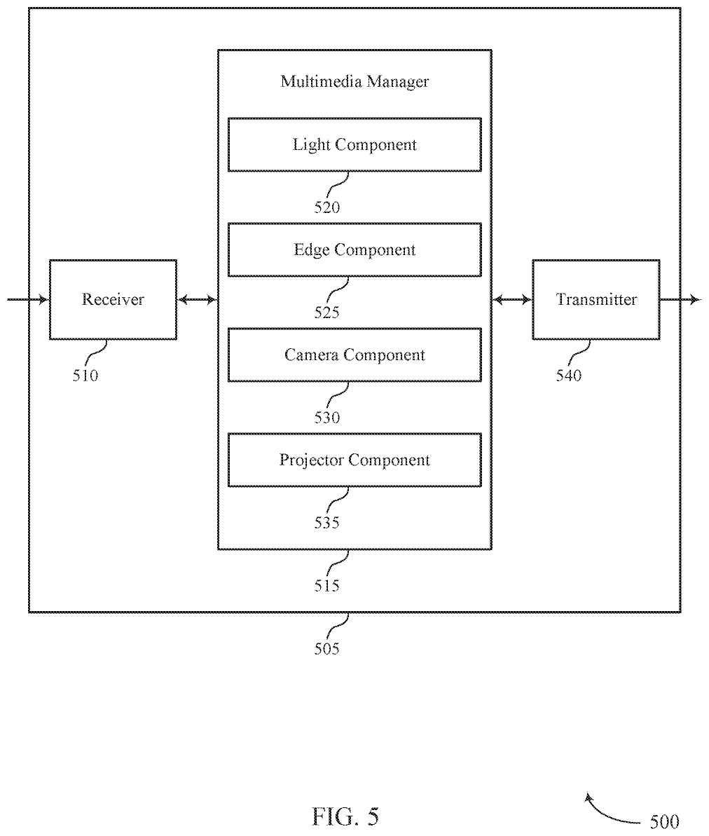

FIG. 5 shows a block diagram 500 of a device 505 that supports display notch mitigation for cameras and projectors in accordance with aspects of the present disclosure. The device 505 may be an example of aspects of a device 405 or a device 105 as described herein. The device 505 may include a receiver 510, a multimedia manager 515, and a transmitter 540. The device 505 may also include a processor. Each of these components may be in communication with one another (e.g., via one or more buses).

The receiver 510 may receive information such as packets, user data, or control information associated with various information channels (e.g., control channels, data channels, and information related to display notch mitigation for cameras and projectors, etc.). Information may be passed on to other components of the device 505. The receiver 510 may be an example of aspects of the transceiver 720 described with reference to FIG. 7. The receiver 510 may utilize a single antenna or a set of antennas.

The multimedia manager 515 may be an example of aspects of the multimedia manager 415 as described herein. The multimedia manager 515 may include a light component 520, an edge component 525, a camera component 530, and a projector component 535. The multimedia manager 515 may be an example of aspects of the multimedia manager 710 described herein.

The light component 520 may receive a set of light rays via an upper surface of a prism, where the prism and a camera assembly of the device are positioned behind a display substrate of the device and the upper surface of the prism is positioned at an edge of the display substrate. The edge component 525 may reflect the set of light rays across a reflection surface, the reflection surface forming an angle with the upper surface of the prism. The camera component 530 may receive the set of light rays via the camera assembly positioned behind the display substrate based on reflecting the set of light rays across the reflection surface.

The projector component 535 may emit a set of light rays via a projector assembly positioned behind a display substrate of the device. The edge component 525 may reflect the set of light rays across a reflection surface, the reflection surface forming an angle with an upper surface of a prism, where the upper surface of the prism is positioned at an edge of the display substrate. The light component 520 may emit the set of light rays via the upper surface of the prism based on reflecting the set of light rays across the reflection surface.

The transmitter 540 may transmit signals generated by other components of the device 505. In some examples, the transmitter 540 may be collocated with a receiver 510 in a transceiver module. For example, the transmitter 540 may be an example of aspects of the transceiver 720 described with reference to FIG. 7. The transmitter 540 may utilize a single antenna or a set of antennas.

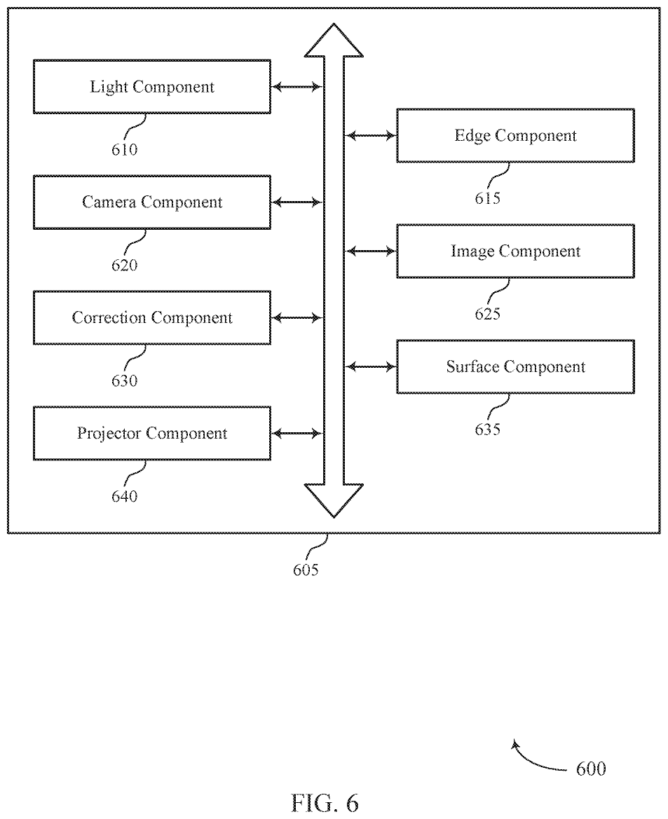

FIG. 6 shows a block diagram 600 of a multimedia manager 605 that supports display notch mitigation for cameras and projectors in accordance with aspects of the present disclosure. The multimedia manager 605 may be an example of aspects of a multimedia manager 415, a multimedia manager 515, or a multimedia manager 710 described herein. The multimedia manager 605 may include a light component 610, an edge component 615, a camera component 620, an image component 625, a correction component 630, a surface component 635, and a projector component 640. Each of these modules may communicate, directly or indirectly, with one another (e.g., via one or more buses).

The light component 610 may receive a set of light rays via an upper surface of a prism. The prism and a camera assembly of a device may be positioned behind a display substrate of the device and the upper surface of the prism may be positioned at an edge of the display substrate. In some examples, the light component 610 may emit the set of light rays via the upper surface of the prism based on reflecting the set of light rays across the reflection surface. The light component 610 may receive the set of light rays via a lower surface of the prism based on the lower surface of the prism being flush with the camera assembly. The light component 610 may receive the set of light rays via a lower surface of the prism based on a gap between the lower surface of the prism and the camera assembly. In some examples, the light component 610 may emit the set of light rays via a lower surface of the prism based on that the lower surface of the prism is flush with the projector assembly. In some other examples, the light component 610 may emit the set of light rays via a lower surface of the prism based on a gap between the lower surface of the prism and the projector assembly.

The edge component 615 may reflect the set of light rays across a reflection surface, the reflection surface forming an angle with the upper surface of the prism. In some examples, the edge component 615 may reflect the set of light rays across a reflection surface, where the reflection surface forms an angle with an upper surface of a prism. The upper surface of the prism may be positioned at an edge of the display substrate. The camera component 620 may receive the set of light rays via the camera assembly positioned behind the display substrate based on reflecting the set of light rays across the reflection surface. In some cases, the camera assembly includes an infrared camera, a time-of-flight camera, a thermographic camera, or a visible camera. The projector component 640 may emit a set of light rays via a projector assembly positioned behind a display substrate of the device. In some cases, the projector assembly includes a structured light projector, a flood illumination projector, or a time-of-flight projector. The image component 625 may capture an image via the device based on the received set of light rays via the camera assembly. In some examples, the image component 625 may store the captured image at a local memory or a remote memory associated with the device.

The correction component 630 may perform a brightness correction operation based on the received set of light rays via the camera assembly, where capturing the image includes. In some examples, the correction component 630 may perform the brightness correction operation based on an optical ray tracing operation on the received set of light rays. In some examples, the correction component 630 may calibrate the camera assembly of the device based on the received set of light rays, where the set of light rays includes a uniform set of light rays, and perform the brightness correction operation based on calibrating the camera assembly. In some examples, the correction component 630 may output a representation of a brightness corrected image based on performing the brightness correction. In some examples, the correction component 630 may perform a brightness correction operation based on the emitted set of light rays via the projector assembly. In some other examples, the correction component 630 may output a representation of an image via the projector assembly.

The correction component 630 may perform the brightness correction operation based on an optical ray tracing operation on the emitted set of light rays. In some examples, the correction component 630 may calibrate the projector assembly of the device based on the emitted set of light rays, where the set of light rays includes a uniform set of light rays, and perform the brightness correction operation based on calibrating the projector assembly. The surface component 635 may determine dimensions of the upper surface of the prism are equal to dimensions of the reflection surface. In some examples, the surface component 635 may determine dimensions of the upper surface of the prism are less than dimensions of the reflection surface.

FIG. 7 shows a diagram of a system 700 including a device 705 that supports display notch mitigation for cameras and projectors in accordance with aspects of the present disclosure. The device 705 may be an example of or include the components of device 405, device 505, or a device as described herein. The device 705 may include components for bi-directional voice and data communications including components for transmitting and receiving communications, including a multimedia manager 710, an I/O controller 715, a transceiver 720, an antenna 725, memory 730, a processor 740, and a coding manager 750. These components may be in electronic communication via one or more buses (e.g., bus 745).

The multimedia manager 710 may receive a set of light rays via an upper surface of a prism. The prism and a camera assembly of the device 705 are positioned behind a display substrate of the device 705 and the upper surface of the prism is positioned at an edge of the display substrate. The multimedia manager 710 may reflect the set of light rays across a reflection surface. The reflection surface may form an angle with the upper surface of the prism. The multimedia manager 710 may receive the set of light rays via the camera assembly positioned behind the display substrate based on reflecting the set of light rays across the reflection surface. The multimedia manager 710 may, additionally or alternatively, emit a set of light rays via a projector assembly positioned behind a display substrate of the device 705. The multimedia manager 710 may reflect the set of light rays across a reflection surface. The reflection surface may form an angle with an upper surface of a prism. The upper surface of the prism may be positioned at an edge of the display substrate. The multimedia manager 710 may emit the set of light rays via the upper surface of the prism based on reflecting the set of light rays across the reflection surface.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas. In some cases, the device 705 may include a single antenna 725. However, in some cases, the device 705 may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor 740 to perform various functions described herein. In some cases, the memory 730 may contain, among other things, a BIOS which may control basic hardware or software operation such as the interaction with peripheral components or devices. The code 735 may include instructions to implement aspects of the present disclosure, including instructions to support device displays. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting display notch mitigation for cameras and projectors).

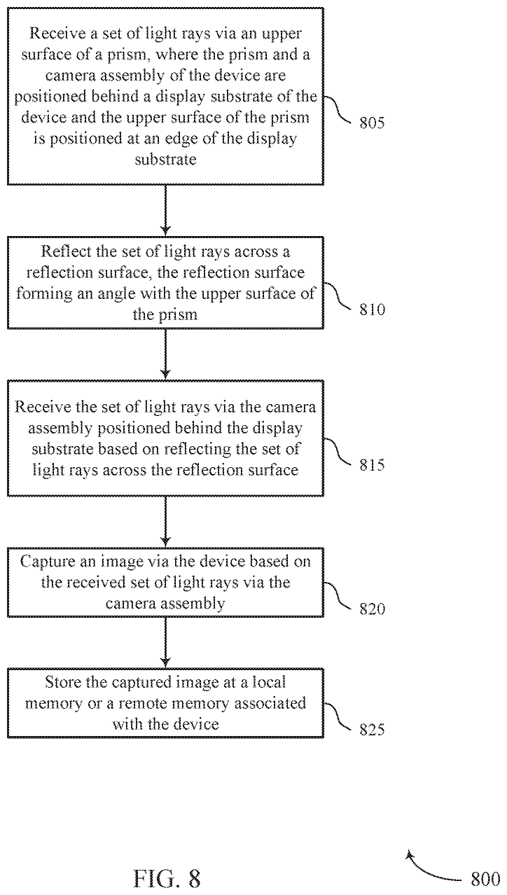

FIG. 8 shows a flowchart illustrating a method 800 that supports display notch mitigation for cameras and projectors in accordance with aspects of the present disclosure. The operations of method 800 may be implemented by a device or its components as described herein. For example, the operations of method 800 may be performed by a multimedia manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may receive a set of light rays via an upper surface of a prism, where the prism and a camera assembly of the device are positioned behind a display substrate of the device and the upper surface of the prism is positioned at an edge of the display substrate. The operations of 805 may be performed according to the methods described herein. In some examples, aspects of the operations of 805 may be performed by a light component as described with reference to FIGS. 4 through 7.

At 810, the device may reflect the set of light rays across a reflection surface, the reflection surface forming an angle with the upper surface of the prism. The operations of 810 may be performed according to the methods described herein. In some examples, aspects of the operations of 810 may be performed by an edge component as described with reference to FIGS. 4 through 7.

At 815, the device may receive the set of light rays via the camera assembly positioned behind the display substrate based on reflecting the set of light rays across the reflection surface. The operations of 815 may be performed according to the methods described herein. In some examples, aspects of the operations of 815 may be performed by a camera component as described with reference to FIGS. 4 through 7.

At 820, the device may capture an image via the device based on the received set of light rays via the camera assembly. The operations of 820 may be performed according to the methods described herein. In some examples, aspects of the operations of 820 may be performed by an image component as described with reference to FIGS. 4 through 7.

At 825, the device may store the captured image at a local memory or a remote memory associated with the device. The operations of 825 may be performed according to the methods described herein. In some examples, aspects of the operations of 825 may be performed by an image component as described with reference to FIGS. 4 through 7.

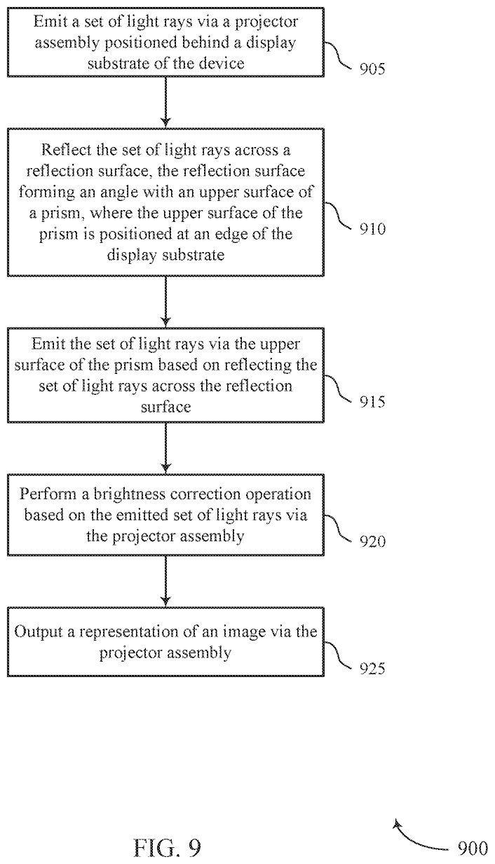

FIG. 9 shows a flowchart illustrating a method 900 that supports display notch mitigation for cameras and projectors in accordance with aspects of the present disclosure. The operations of method 900 may be implemented by a device or its components as described herein. For example, the operations of method 900 may be performed by a multimedia manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may emit a set of light rays via a projector assembly positioned behind a display substrate of the device. The operations of 905 may be performed according to the methods described herein. In some examples, aspects of the operations of 905 may be performed by a projector component as described with reference to FIGS. 4 through 7.

At 910, the device may reflect the set of light rays across a reflection surface, the reflection surface forming an angle with an upper surface of a prism, where the upper surface of the prism is positioned at an edge of the display substrate. The operations of 910 may be performed according to the methods described herein. In some examples, aspects of the operations of 910 may be performed by an edge component as described with reference to FIGS. 4 through 7.

At 915, the device may emit the set of light rays via the upper surface of the prism based on reflecting the set of light rays across the reflection surface. The operations of 915 may be performed according to the methods described herein. In some examples, aspects of the operations of 915 may be performed by a light component as described with reference to FIGS. 4 through 7.

At 920, the device may perform a brightness correction operation based on the emitted set of light rays via the projector assembly. The operations of 920 may be performed according to the methods described herein. In some examples, aspects of the operations of 920 may be performed by a correction component as described with reference to FIGS. 4 through 7.

At 925, the device may output a representation of an image via the projector assembly. The operations of 925 may be performed according to the methods described herein. In some examples, aspects of the operations of 925 may be performed by a correction component as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method at a device, comprising:
receiving a plurality of light rays via an upper surface of a prism, wherein the prism and a camera assembly of the device are positioned behind a display substrate of the device and the upper surface of the prism is positioned at an edge of the display substrate;
reflecting the plurality of light rays across a reflection surface, the reflection surface forming an angle with the upper surface of the prism; and
receiving the plurality of light rays via the camera assembly positioned behind the display substrate based at least in part on reflecting the plurality of light rays across the reflection surface.

2. The method of claim 1, further comprising:
capturing an image via the device based at least in part on the received plurality of light rays via the camera assembly; and
storing the captured image at a local memory or a remote memory associated with the device.

3. The method of claim 2, further comprising:
performing a brightness correction operation based at least in part on the received plurality of light rays via the camera assembly, wherein capturing the image comprises; and
capturing the image via the device based at least in part on performing the brightness correction operation.

4. The method of claim 3, wherein performing the brightness correction operation comprises:
performing the brightness correction operation based at least in part on an optical ray tracing operation on the received plurality of light rays.

5. The method of claim 3, further comprising:
calibrating the camera assembly of the device based at least in part on the received plurality of light rays, wherein the plurality of light rays comprises a uniform plurality of light rays, and performing the brightness correction operation comprises:
performing the brightness correction operation based at least in part on calibrating the camera assembly.

6. The method of claim 3, further comprising:
outputting a representation of a brightness corrected image based at least in part on performing the brightness correction.

7. The method of claim 1, further comprising:
receiving the plurality of light rays via a lower surface of the prism based at least in part on the lower surface of the prism being flush with the camera assembly.

8. The method of claim 1, further comprising:
receiving the plurality of light rays via a lower surface of the prism based at least in part on a gap between the lower surface of the prism and the camera assembly.

9. The method of claim 1, wherein dimensions of the upper surface of the prism are equal to dimensions of the reflection surface.

10. The method of claim 1, wherein dimensions of the upper surface of the prism are less than dimensions of the reflection surface.

11. The method of claim 1, wherein the camera assembly comprises an infrared camera, a time-of-flight camera, a thermographic camera, or a visible camera.

12. A method at a device, comprising:
emitting a plurality of light rays via a projector assembly positioned behind a display substrate of the device;
reflecting the plurality of light rays across a reflection surface, the reflection surface forming an angle with an upper surface of a prism, wherein the upper surface of the prism is positioned at an edge of the display substrate; and
emitting the plurality of light rays via the upper surface of the prism based at least in part on reflecting the plurality of light rays across the reflection surface.

13. The method of claim 12, further comprising:
performing a brightness correction operation based at least in part on the emitted plurality of light rays via the projector assembly; and
outputting a representation of an image via the projector assembly.

14. The method of claim 13, wherein performing the brightness correction operation comprises:
performing the brightness correction operation based at least in part on an optical ray tracing operation on the emitted plurality of light rays.

15. The method of claim 13, further comprising:
calibrating the projector assembly of the device based at least in part on the emitted plurality of light rays, wherein the plurality of light rays comprises a uniform plurality of light rays, and performing the brightness correction operation comprises:
performing the brightness correction operation based at least in part on calibrating the projector assembly.

16. The method of claim 12, further comprising:
emitting the plurality of light rays via a lower surface of the prism based at least in part on that the lower surface of the prism is flush with the projector assembly.

17. The method of claim 12, further comprising:
emitting the plurality of light rays via a lower surface of the prism based at least in part on a gap between the lower surface of the prism and the projector assembly.

18. The method of claim 12, wherein the projector assembly comprises a structured light projector, a flood illumination projector, or a time-of-flight projector.

19. An apparatus comprising:
a prism configured to receive a plurality of light rays via an upper surface of the prism, wherein the prism and a camera assembly of the apparatus are positioned behind a display substrate of the apparatus and the upper surface of the prism is positioned at an edge of the display substrate;
a reflection surface configured to reflect the plurality of light rays across the reflection surface, the reflection surface forming an angle with the upper surface of the prism; and
a camera assembly configured to receive the plurality of light rays based at least in part on reflecting the plurality of light rays across the reflection surface, wherein the camera assembly is positioned behind the display substrate.

20. The apparatus of claim 19, further comprising:
a processor;
memory coupled with the processor;
instructions stored in the memory and executable by the processor to cause the apparatus to;
capture an image via the apparatus based at least in part on the received plurality of light rays via the camera assembly; and
store the captured image at a local memory or a remote memory associated with the apparatus.
